(19) United States
(12) Patent Application Publication
(10) Pub. No.: US 2011/0035393 A1
(43) Pub. Date: Feb. 10, 2011

(54) FILE SELECTION SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/580,273

(22) Filed: Oct. 16, 2009

(30) Foreign Application Priority Data
Aug. 7, 2009 (CN) 200910305371.X

(51) Int. Cl. G06F 17/30

(52) U.S. Cl. 707/758; 707/E17.001

(57) ABSTRACT

A file selection system includes a gravity sensor and a processing unit. The gravity sensor is mounted on an electronic device to measure gravity of the electronic device and output electronic signals correspondingly. The processing unit receives the electronic signals to obtain an angle of inclination of the electronic device relative to a datum plane correspondingly, receives the angle of inclination of the electronic device relative to the datum plane, and selects a file correspondingly from a plurality of files with different shooting angles. The electronic device displays the selected image.

### BACKGROUND

1. Technical Field

The present disclosure relates to a file selection system and a file selecting method.

2. Description of Related Art

Conventional electronic media viewers cannot change features of viewed media, such as different visual angles, according to actions of users. In other words, the conventional media viewers are non-interactive and so are not as entertaining as they could be.

### BRIEF DESCRIPTION OF THE DRAWINGS

FIG. 1 is a schematic block diagram of an exemplary embodiment of a file selection system, the file selection system includes a storage system.

FIG. 2 is a schematic block diagram of the storage system of FIG. 1.

FIGS. 3A-3C are schematic diagrams of an electronic device under three statuses using the file selection system of FIG. 1.

FIG. 4 is a schematic diagram of images captured by a camera under the statuses of the electronic device in FIGS. 3A-3C, respectively.

FIG. 5 is a schematic diagram of images displayed by the electronic device in FIGS. 3A-3C, respectively.

FIG. 6 is a flowchart of an exemplary embodiment of a file selecting method.

### DETAILED DESCRIPTION

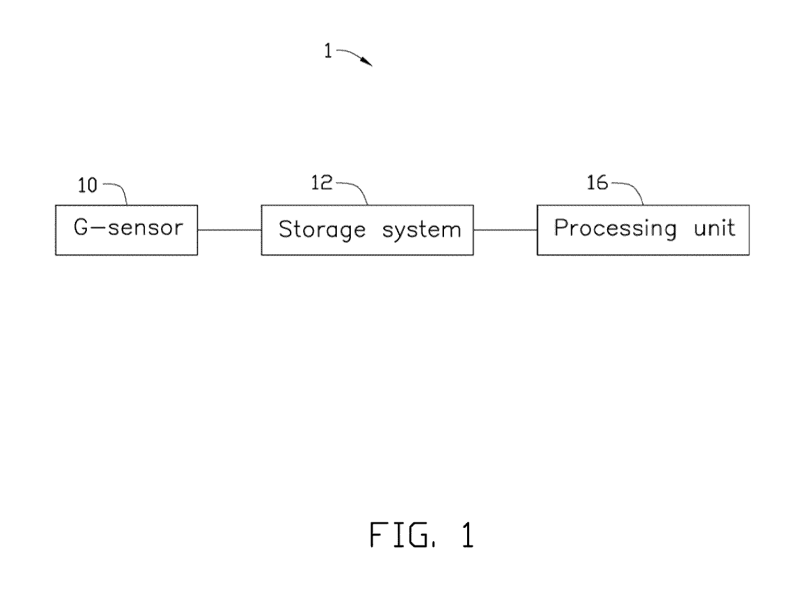

Referring to FIG. 1, an exemplary embodiment of a file selection system 1 is used in an electronic device, such as a mobile phone. The file selection system 1 includes a gravity sensor (G-sensor) 10, a storage system 12, and a processing unit 16. The file selection system 1 is operable to select a file according to status of the mobile phone.

The G-sensor 10 is mounted on the mobile phone to convert sensed direction of gravity relative to the mobile phone to electronic signals, and transmit the electronic signals to the storage system 12. It can be understood that the G-sensor 10 uses well known recognition technology to convert the sensed direction of gravity of the mobile phone to electronic signals.

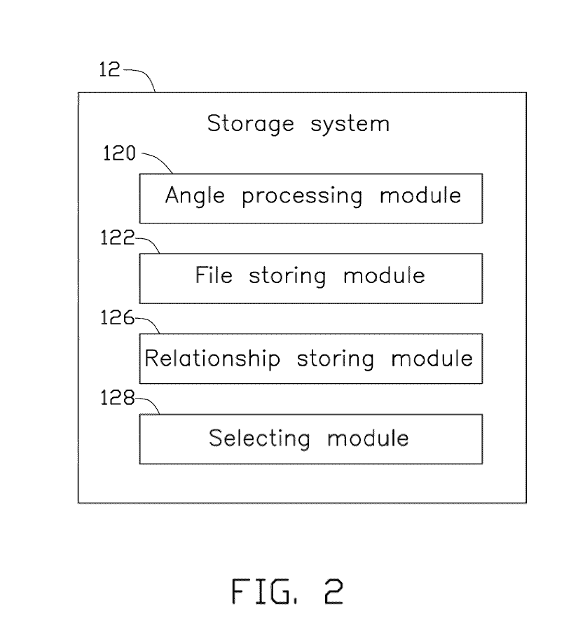

Referring to FIG. 2, the storage system 12 includes an angle processing module 120, a file storing module 122, a relationship storing module 126, and a selecting module 128. The angle processing module 120 and the selecting module 128 may include one or more computerized instructions and are executed by the processing unit 16.

The angle processing module 120 receives the electronic signals from the G-sensor 10 to obtain an angle of inclination of the mobile phone relative to a datum plane correspondingly. It can be understood that the angle processing module 120 calculates and compares voltages of the G-sensor 10 corresponding to the position of the mobile phone relative to the datum plane to obtain the angle of inclination of the mobile phone relative to the datum plane.

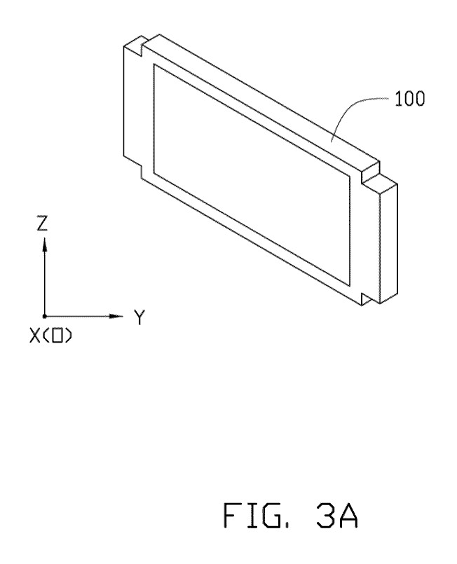

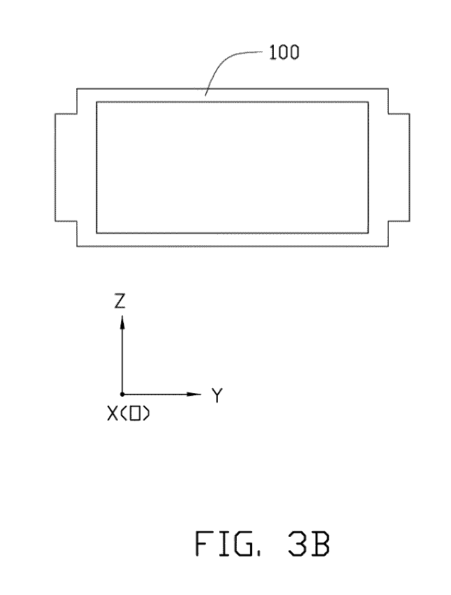

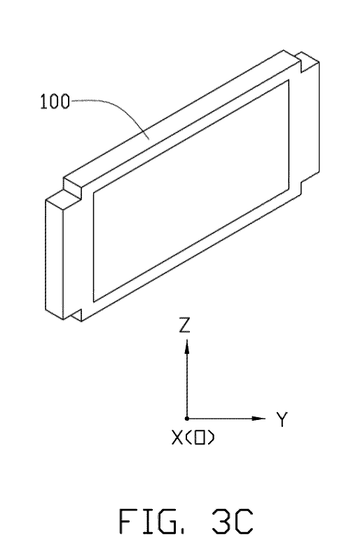

FIGS. 3A-3C show when an angle of 135 degrees exists between a mobile phone 100 under a first status and a datum plane YOZ, when an angle of 0 degrees exists between the mobile phone 100 under a second status and the datum plane YOZ, and when angle of 45 degrees exists between the mobile phone 100 under a third status and the datum plane YOZ.

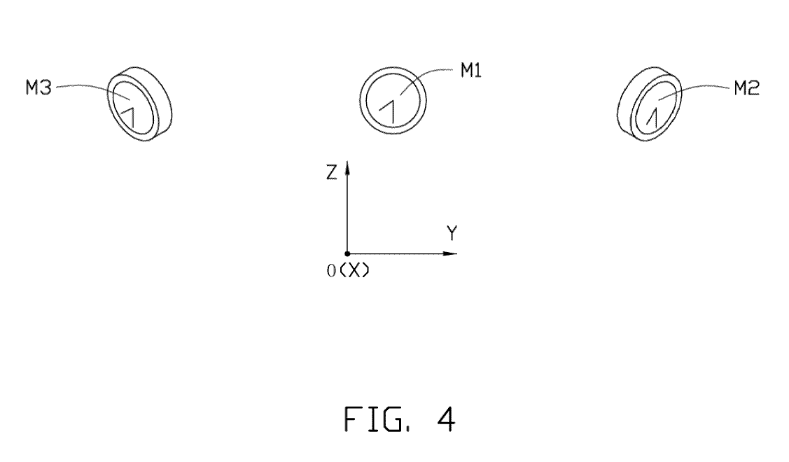

The file storing module 122 stores a plurality of files, such as images or movies, in advance. In the embodiment, the file storing module 122 stores a plurality of images, for example. The plurality of images have the same subject matter but the images are captured from different shooting angles. For example, the cameramen may capture an image for each subject from three different shooting angles, such as directly facing a front of a subject for a shooting angle, which we will call 0 degrees shooting angle, obliquely facing the left side of the subject for a shooting angle, which we will call 45 degrees left, and obliquely facing the right side of the subject for a shooting, which we will call 45 degrees right. Referring to FIG. 4, the file storing module 122 stores three images M1, M2, and M3. The image M1 was captured with the shooting angle of 0 degrees. The image M2 was captured with the shooting angle of 45 degrees left. The image M3 was captured with the shooting angle of 45 degrees right.

The relationship storing module 126 stores a plurality of relationships between shooting angles and angles of inclination of the mobile phone 100 relative to the datum plane. For example, the shooting angle of 0 degrees corresponds to an angle of inclination of 0 degrees. The shooting angle of 45 degrees left corresponds to an angle of inclination of 45 degrees. The shooting angle of 45 degrees right corresponds to an angle of inclination of 135 degrees.

The selecting module 128 receives the angle of inclination of the mobile phone 100 relative to the datum plane from the angle processing module 120, and selects an image with a corresponding shooting angle according to the plurality of relationships stored in the relationship storing module 126. The selected image is displayed by the mobile phone 100.

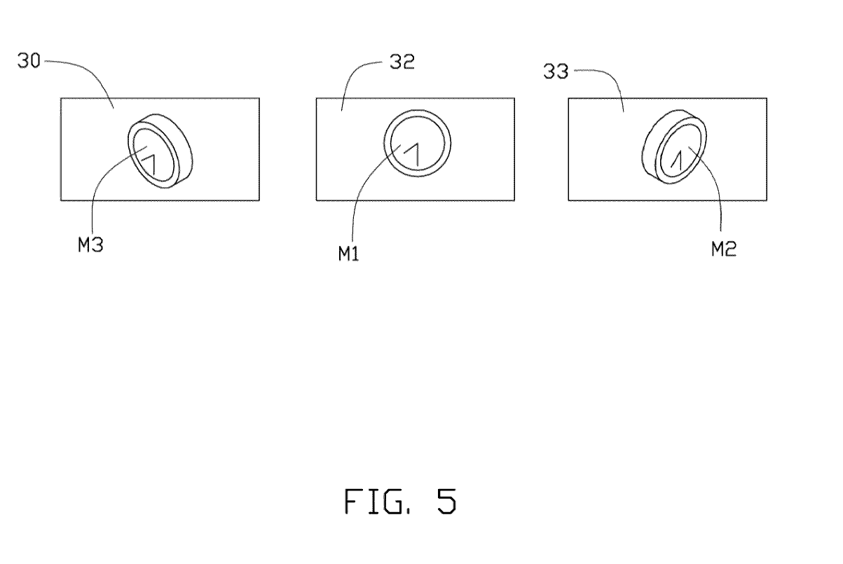

Referring to FIG. 5, upon the condition that the angle of inclination of the mobile phone 100 under the first status relative to the datum plane YOZ is 135 degrees, the selecting module 128 selects the image M3. The mobile phone 100 displays the image M3. Upon the condition that the angle of inclination of the mobile phone 100 under the second status relative to the datum plane YOZ is 0 degrees, the selecting module 128 selects the image M1. The mobile phone 100 displays the image M1. Upon the condition that the angle of inclination of the mobile phone 100 under the third status relative to the datum plane YOZ is 45 degrees, the selecting module 128 selects the image M2. The mobile phone 100 displays the image M2.

In other embodiments, the file storing module 122 stores more images or a plurality of movies. Each image or movie has a shooting angle. When the mobile phone 100 has a different angle of inclination, the selecting module 128 selects a corresponding image or movie. The selected image or movie is displayed by the mobile phone 100. As a result, users can view different images from the mobile phone 100 at different positions. In addition, in other embodiments, the datum plane may be other planes or multi-planes.

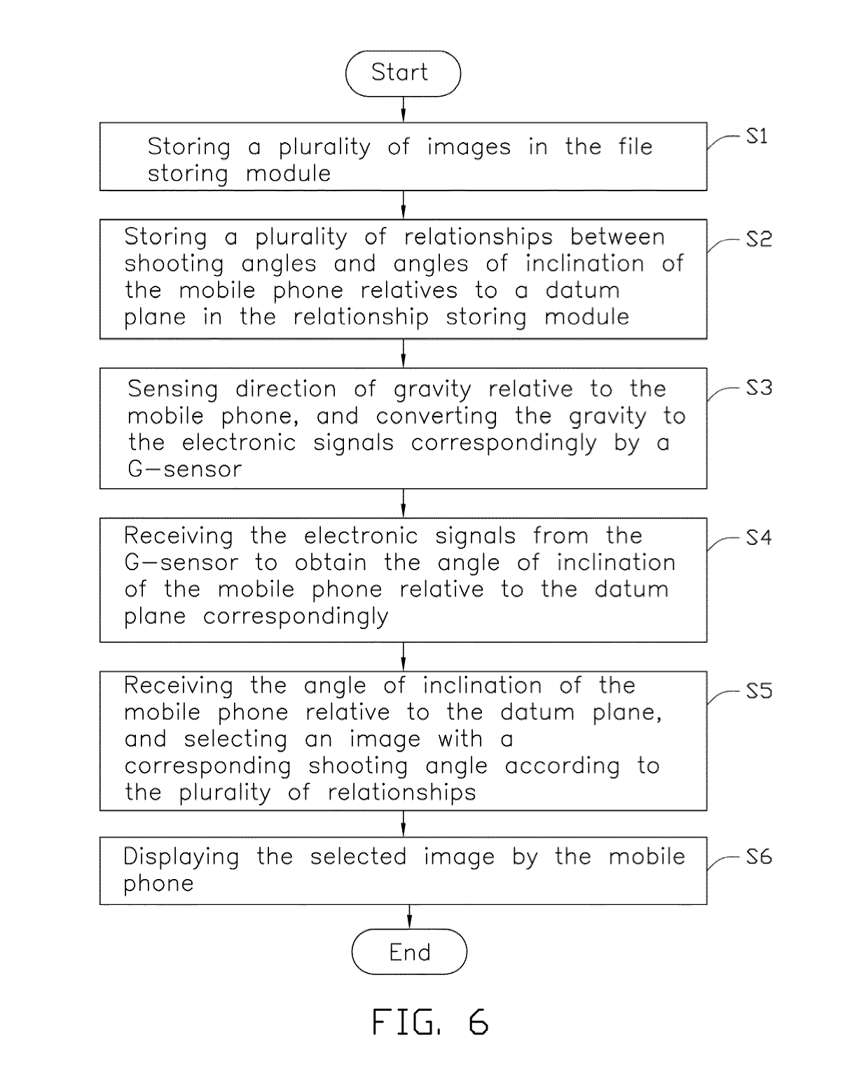

Referring to FIG. 6, an exemplary embodiment of a file selecting method includes the following steps.

In step S1, the plurality of images are stored in the file storing module 122. The images have the same subject matter but each image is captured from different shooting angles. For example, the images M1, M2, and M3 are stored in the file storing module 122. The image M1 was captured with the shooting angle of 0 degrees. The image M2 was captured with the shooting angle of 45 degrees left. The image M3 was captured with the shooting angle of 45 degrees right.

In step S2, a plurality of relationships between shooting angles and angles of inclination of the mobile phone 100 relative to the datum plane are stored in the relationship storing module 126. For example, the shooting angle of 0 degrees corresponds to the angle of inclination of 0 degrees. The shooting angle of 45 degrees left corresponds to the angle of inclination of 45 degrees. The shooting angle of 45 degrees right corresponds to the angle of inclination of 135 degrees.

In step S3, the G-sensor 10 senses direction of gravity relative to the mobile phone 100, and converts the gravity to the electronic signals correspondingly.

In step S4, the angle processing module 120 receives the electronic signals from the G-sensor 10 to obtain the angle of inclination of the mobile phone 100 relative to the datum plane correspondingly. It can be understood that the angle processing module 120 calculates and compares voltages of the G-sensor 10 when the mobile phone is parallel with the datum plane and when the mobile phone is tilted relative to the datum plane to obtain the angle of inclination of the mobile phone relative to the datum plane.

In step S5, the selecting module 128 receives the angle of inclination of the mobile phone 100 relative to the datum plane from the angle processing module 120, and selects an image with a corresponding shooting angle according to the plurality of relationships stored in the relationship storing module 126.

In step S6, the mobile phone 100 displays the selected image. As a result, users can view different images from the mobile phone 100 at different positions.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A file selection system comprising:
a gravity sensor mounted on an electronic device to measure gravity of the electronic device and output electronic signals correspondingly;
a processing unit; and
a storage system connected to the processing unit and storing one or more modules to be executed by the processing unit, wherein the one or more modules comprise:
an angle processing module to receive the electronic signals to obtain an angle of inclination of the electronic device relative to a datum plane correspondingly; and
a selecting module to receive the angle of inclination of the electronic device relative to the datum plane, and select a file correspondingly from a plurality of files with different shooting angles, wherein the selected file is operable to be displayed by the electronic device.

2. The file selection system of claim 1, wherein the plurality of files comprise a plurality of images or movies.

3. The file selection system of claim 1, wherein the storage system further comprises a file storing module, the plurality of files with different shooting angles are stored in the file storing module.

4. The file selection system of claim 1, wherein the storage system further comprises a relationship storing module, the relationship storing module stores a plurality of relationships between the shooting angles of the files and the angles of inclination of the electronic device relative to the datum plane.

5. A file selecting method comprising:
measuring gravity of an electronic device, and converting the gravity of the electronic device to electronic signals by a gravity sensor;
receiving the electronic signals to obtain an angle of inclination of the electronic device relative to a datum plane correspondingly;
receiving the angle of inclination of the electronic device relative to the datum plane, and selecting a file correspondingly from a plurality of files with different shooting angles; and
displaying the selected file by the electronic device.

6. The file selecting method of claim 5, wherein the plurality of files comprise a plurality of images or movies.

7. The file selecting method of claim 5, before the step of measuring gravity of the electronic device, further comprising:
storing the plurality of files in a file storage system in advance.

8. The file selecting method of claim 5, before the step of measuring gravity of the electronic device, further comprising:
storing a plurality of relationships between the shooting angles of the files and the angle of inclination of the electronic device relative to the datum plane in a storage system in advance.
